(19) United States
(12) Patent Application Publication
(10) Pub. No.: US 2026/0121884 A1
(43) Pub. Date: Apr. 30, 2026

(54) INTEGRATED CIRCUIT AND METHOD FOR CONTROLLER AREA NETWORK COMMUNICATION

(71) Applicant: STMicroelectronics International N.V., Geneva (CH)

(72) Inventors: Nicolas Moeneclaey, Vourey (FR); Christophe Roussel, Claix (FR); Olivier Masson, Saint paul de varces (FR)

(21) Appl. No.: 19/354,351

(22) Filed: Oct. 9, 2025

(30) Foreign Application Priority Data
Oct. 31, 2024 (FR) FR2411927

(51) Int. Cl. H04L 12/40

(52) U.S. Cl. CPC H04L 12/40013; H04L 12/40039; H04L 2012/40215

(57) ABSTRACT

According to one aspect, an integrated circuit includes a digital processing unit (MCU), a transceiver circuit (TRC) configured to transmit data between the MCU and a Controller Area Network (CAN) data bus, the transceiver circuit configured to deliver differential signals, CANH and CANL, according to a dominant mode and a recessive mode, each transition of the differential signals CANH and CANL between the dominant mode and the recessive mode being synchronized using adaptation bits received by the transceiver circuit, an adjustment circuit (ADPC) for adjusting at least one adaptation bit according to at least one comparison between the common mode of the differential signals CANH and CANL and at least one threshold voltage.

### CROSS-REFERENCE TO RELATED APPLICATIONS

This application claims the benefit of French Patent Application No. 2411927, filed on October 31, 2024, which application is hereby incorporated herein by reference.

### TECHNICAL FIELD

Embodiments and implementations relate to communication by Controller Area Network (CAN) bus.

### BACKGROUND

The CAN protocol is normally used in motor vehicles for managing communications between various electronic devices, such as sensors, actuators and control units. A CAN network is thus defined between these various electronic devices, connected together by a CAN bus. Each electronic device then forms a node of the CAN network.

A CAN bus includes two wires configured to transport two signals CANH (CAN High) and CANL (CAN Low) between nodes of the CAN network. The signals CANH and CANL are generated by the transceiver circuit of the various electronic devices of the CAN network.

A CAN bus can operate in a dominant mode or in a recessive mode.

In dominant mode, the potential difference between the signal CANH and the signal CANL is high. In particular, the signal CANH reaches a high level, of the order of 3.5 V, and the signal CANL a low level, of the order of 1.5 V.

In recessive mode, the levels of the signals CANH and CANL converge around 2.5 V, thus reducing the potential difference.

However, a time shift may occur between the signals CANH and CANL when there is a change of operating mode.

This time shift may cause brief pulses (or glitches) on the common mode of the signals CANH and CANL. The common mode of the signals CANH and CANL corresponds to the voltage component common to the two signal lines with respect to a common reference point, for example with respect to earth. The common mode can thus correspond to the mean of the voltages of the signals CANH and CANL.

These brief pulses may cause interference on the operation of the CAN bus. For example, this interference may increase the undesirable electromagnetic emissions or interference (EMI) of the CAN bus. These electromagnetic emissions may affect neighboring electronic circuits. Furthermore, this interference may be amplified according to the temperature.

There is therefore a need to propose a solution for improving communication in a CAN network by reducing the interference that may in particular cause undesirable electromagnetic emissions.

### SUMMARY

According to one aspect, an integrated circuit is proposed, comprising: a digital processing unit, in particular a microcontroller, a transceiver circuit configured to transmit data between the digital processing unit and a Controller Area Network (CAN) data bus, the transceiver circuit being configured to deliver differential signals, called CANH and CANL, according to a dominant mode and a recessive mode, each transition of the differential signals CANH and CANL between the dominant mode and the recessive mode being synchronized using adaptation bits received by the transceiver circuit, and a circuit for adjusting at least one adaptation bit according to at least one comparison between the common mode of the differential signals CANH and CANL and at least one threshold voltage.

Such an adjustment circuit makes it possible to reduce the interference on the common mode of the signals CANH and CANL by adjusting the adaptation bits in order to best synchronize the signals CANH and CANL. Such an adjustment circuit thus makes it possible to limit the undesirable electromagnetic emissions (EMI) of the CAN bus resulting from the interference on the common mode of the signals CANH and CANL.

Furthermore, such an adjustment circuit has the advantage of not being impacted by changes of temperature. This is because such an adjustment circuit regulates itself automatically when there are drifts in temperature because of the monitoring of the common mode of the signals CANL and CANH.

In an advantageous embodiment, the adjustment circuit comprises: a detection circuit configured to detect interference on the common mode of the differential signals CANH and CANL, and a processing circuit configured to adjust at least one adaptation bit when interference on the common mode is detected by the detection circuit.

Advantageously, the digital processing unit is configured to deliver a control signal indicating the mode of the signals CANL and CANH. The processing circuit is then configured to receive the control signal in order to adapt at least one adaptation bit associated with the transition to the mode of the signals CANL and CANH corresponding to the mode indicated by the control signal when interference is detected by the detection circuit.

Preferably, the detection circuit is configured to receive the signals CANH and CANL and comprises: a first resistive element and a second resistive element connected in series and configured to receive the signals CANL and CANH so as to obtain the common mode of these signals CANL and CANH on a common node between the first resistive element and the second resistive element, a third resistive element, a fourth resistive element; and a current source connected in series between the common node of the first resistive element and of the second resistive element and a reference node, in particular to an earth, a low-pass filter having an input connected to a common node between the third resistive element and the fourth resistive element so as to generate as an output a threshold voltage for monitoring the common mode of the signals CANH and CANL, a first comparator having a first input connected to the common node between the first resistive element and the second resistive element, and a second input connected to the output of the low-pass filter, a second comparator having a first input connected to the common node between the fourth resistive element and the current source, and a second input connected to the output of the low-pass filter, and an adding circuit having two inputs connected respectively to the outputs of the first and second comparators, and an output connected to the processing circuit.

Such a detection circuit is simple and occupies little space in the integrated circuit.

Advantageously, the processing circuit comprises: a first counter configured to be incremented whenever interference is detected on the common mode by the detection circuit during a transition to the dominant mode, the value of the first counter defining at least one adaptation bit for the transition to the dominant mode, and a second counter configured to be incremented whenever interference is detected on the common mode by the detection circuit during a transition to the recessive mode, the value of the second counter defining at least one adaptation bit for the transition to the recessive mode.

In an advantageous embodiment, the processing circuit comprises an event-monitoring circuit connected to the output of the detection circuit and being configured to increment, whenever interference is detected, the first counter or the second counter according to the mode of the signals CANH and CANL indicated by the control signal delivered by the digital processing unit.

According to another aspect, an electronic device is proposed, comprising an integrated circuit as described previously. Such an electronic device can then be integrated in a CAN network.

### BRIEF DESCRIPTION OF THE DRAWINGS

Other advantages and features of the invention will become apparent upon reading the detailed description of non-limiting embodiments, and from the appended drawings wherein:

FIG. 1 illustrates an electronic device configured to operate in a CAN network;

FIG. 2 illustrates signals CANH and CANL according to a dominant mode and a recessive mode;

FIG. 3 illustrates an adjustment circuit including an interference-detection circuit and a processing circuit;

FIG. 4 illustrates a first embodiment of the interference-detection circuit;

FIG. 5 illustrates a second embodiment of the interference-detection circuit; and

FIG. 6 illustrates an embodiment of a processing circuit.

### DETAILED DESCRIPTION OF ILLUSTRATIVE EMBODIMENTS

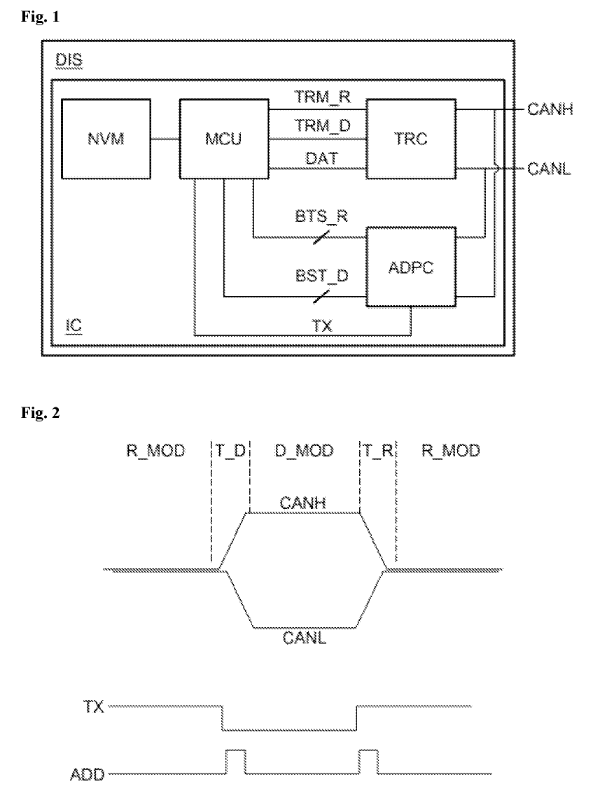

FIG. 1 illustrates an electronic device DIS configured to operate in a Controller Area Network (CAN) network. The electronic device DIS can thus form a node of the CAN network. The electronic device DIS can for example be an element of a motorcar (ECU, ABS box, dashboard, etc.).

The electronic device DIS comprises an integrated circuit IC. The integrated circuit IC comprises a digital processing unit MCU, for example a microcontroller MCU, and a transceiver circuit TRC for implementing a CAN communication. In particular, the transceiver circuit TRC is configured to be connected to a CAN bus connecting the various nodes of the CAN network.

In particular, the transceiver circuit TRC can operate in transmission. In this case, the transceiver circuit is configured to receive data DAT supplied by the digital processing unit MCU in order to transmit them to the CAN bus.

The transceiver circuit TRC can operate in reception. In this case, the transceiver circuit is configured to receive data from the CAN bus in order to transmit them to the digital processing unit MCU.

The transceiver circuit TRC is configured to control the signals CANH and CANL according to a dominant mode or according to a recessive mode. The dominant mode and the recessive mode are defined by the digital processing unit MCU, in particular via a control signal TX.

FIG. 2 illustrates the signals CANH and CANL according to the dominant mode D_MOD and according to the recessive mode R_MOD. An offset of the signals CANH and CANL can cause interference on the common mode of the signals CANH and CANL. This offset can take place during T_D, T_R transitions between the dominant mode D_MOD and the recessive mode R_MOD. This interference may cause undesirable electromagnetic emissions on the CAN bus.

The common mode of the signals CANH and CANL corresponds to the voltage component common to the two signal lines with respect to a common reference point, for example with respect to earth. The common mode can thus correspond to the mean of the voltages of the signals CANH and CANL.

In order to define times for the transitions of the signals CANH and CANL between the dominant mode and the recessive mode, the transceiver circuit TRC is configured to receive at least one digital adaptation signal TRM_R, TRM_D for adjusting the transitions of the signals CANH and CANL. In particular, a digital signal TRM_R can be used for the transitions of the signals CANH and CANL to the recessive mode, and a digital signal TRM_D can be used for the transitions of the signals CANH and CANL to the dominant mode. Each digital adaptation signal TRM_R, TRM_D can be delivered by the digital processing unit MCU. Each digital adaptation signal TRM_R, TRM_D includes several adaptation bits. These adaptation bits can also be designated by the expression "trimming bits". These adaptation bits serve to adjust the edges of the signals CANH and CANL for the transitions between the dominant mode and the recessive mode.

Each digital adaptation signal is taken into account by the transceiver circuit to make adjustments to the signals CANH and CANL in order to synchronize the transitions of the voltage levels of the signals CANH and CANL. This adjustment can for example be made by a timing circuit of the transceiver circuit TLC configurable by the adaptation bits.

In particular, the integrated circuit also includes a circuit ADPC for adjusting adaptation bits.

The circuit ADPC for adjusting adaptation bits is configured to adjust at least one adaptation bit, in particular a plurality of adaptation bits, so that the common mode of the signals CANH and CANL is maintained in an envelope. For example, the adjustment circuit ADPC is configured to adjust adaptation bits BTS_R of the digital adjustment signal TRM_R and to adjust adaptation bits BTS_D of the digital adjustment signal TRM_D. The adaptation bits BTS_R can correspond to N least significant bits of the digital adjustment signal TRM_R. The adaptation bits BTS_D can correspond to N least significant bits of the digital adjustment signal TRM_D. The adaptation bits BTS_R and BTS_D can be transmitted to the digital processing unit, as illustrated, in order to modify the digital adaptation signal TRM_R and TRM_D. In a variant, the adaptation bits can be transmitted directly to the transceiver circuit TRC. In this case, the digital processing unit can simply transmit K most significant bits of the signals TRM_D and TRM_R to the transceiver circuit TRC, K being equal to M-N, where M is the total number of adaptation bits of the adaptation signal TRM_R or TRM_D. These K adaptation bits can be stored in a non-volatile memory NVM that can be accessed in read mode by a digital processing unit MCU. In this case, the digital processing unit MCU can only transmit these K most significant bits to the transceiver circuit TRC, which combines them with the N least significant bits to form the digital adaptation signal TRM_R or TRM_D.

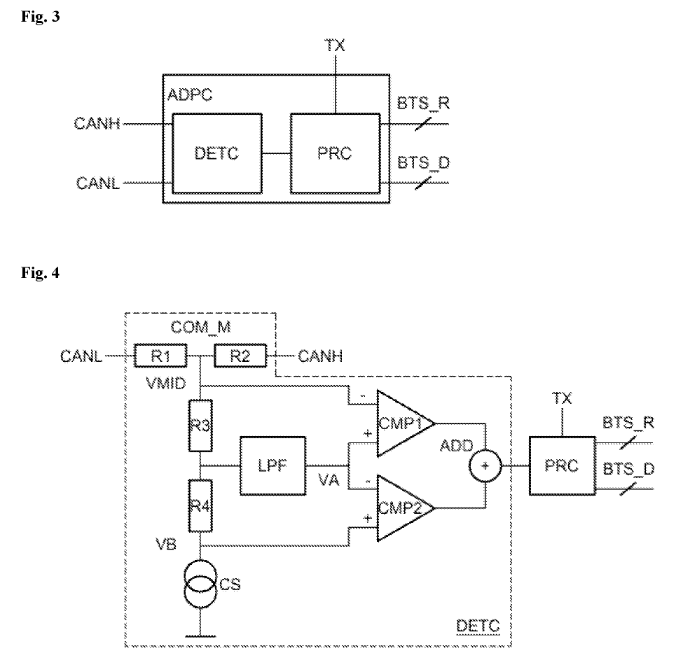

As illustrated in FIG. 3, in order to adjust the adaptation bits, the adjustment circuit ADPC includes an interference-detection circuit DETC and a processing circuit PRC.

The interference-detection circuit DETC is configured to receive as an input the signals CANH and CANL delivered by the transceiver circuit TRC and to determine whether an adjustment of the synchronization is necessary by monitoring the common mode of the signals CANH and CANL. In particular, the interference-detection circuit ADPC is configured to detect interference, in particular glitches, on the common mode of the signals CANH and CANL.

The processing circuit PRC is configured to adjust the value of at least one adaptation bit when a correction to the synchronization of the signals CANL and CANH is required. More particularly, the processing circuit PRC is configured to adjust the adaptation bits when an interference is detected on the common mode of the signals CANH and CANL.

The processing circuit PRC is configured to know whether it is necessary to correct the dominant mode of the recessive mode. To do this, the processing circuit PRC is configured to receive the control signal TX. As seen previously, this control signal TX indicates whether the electronic device DIS is in a dominant or recessive mode. This control signal TX is generated by the digital processing unit. For example, when TX is equal to "0", then the electronic device DIS is in a dominant mode, and when TX is equal to "1", then the electronic device DIS is in a recessive mode.

Thus, when the processing circuit PRC detects that a correction to the synchronization is required when the control signal TX indicates that the electronic device DIS is in a dominant mode, then this means that the correction to the synchronization of the signals CANL and CANH is required for the dominant mode.

Likewise, when the processing circuit PRC detects that a correction to the synchronization is required when the information signal TX indicates that the electronic device DIS is in a recessive mode, then this means that the correction to the synchronization of the signals CANL and CANH is required for the recessive mode.

Such an adjustment circuit ADPC makes it possible to reduce the interference on the common mode of the signals CANH and CANL by adjusting the adaptation bits in order to best synchronize the signals CANH and CANL. The adjustment circuit ADPC thus makes it possible to limit the undesirable electromagnetic emissions (EMI) of the CAN bus resulting from the interference on the common mode of the signals CANH and CANL.

Furthermore, the adjustment circuit ADPC has the advantage of not being impacted by changes of temperature. This is because the adjustment circuit ADPC regulates itself automatically when there are drifts in temperature because of the monitoring of the common mode of the signals CANL and CANH.

FIG. 4 shows a first embodiment of an interference-detection circuit DETC.

The interference-detection circuit DETC comprises a first resistive element R1 having a first terminal configured to receive the signal CANL.

The interference-detection circuit DETC also comprises a second resistive element R2 having a first terminal configured to receive the signal CANH.

The first resistive element R1 and the second resistive element R2 each have a second terminal connected to a common node of the adjustment circuit.

Advantageously, the first resistive element R1 and the second resistive element R2 have the same ohmic value. This makes it possible to obtain a voltage on the common node, between the first resistive element R1 and the second resistive element R2, corresponding to the voltage of the common mode. Preferably, the value of the first resistive element R1 and of the second resistive element R2 is selected so as to avoid disturbing the CAN communication. In particular, this value is selected to have an order of magnitude greater than that of the differential resistance of the CAN bus in the recessive mode.

The interference-detection circuit DETC also comprises a third resistive element R3 having a first terminal connected to the common node between the first resistive element R1 and the second resistive element R2.

The interference-detection circuit DETC also comprises a fourth resistive element R4. This fourth resistive element R4 has a first terminal connected to a second terminal of the third resistive element R3.

The interference-detection circuit DETC also comprises a current source CS having a first terminal connected to a second terminal of the fourth resistive element R4, and a second terminal connected to a reference node. This reference node can in particular be connected to an earth. Preferably, the current defined by the current source is relatively low in order to avoid drawing off an excessive quantity of current on the signals CANL and CANH, which could impact the CAN communication.

Thus the third resistive element R3, the fourth resistive element R4 and the current source CS are disposed in series between the common node between the first resistive element R1 and the second resistive element R2, and the reference node to which the second terminal of the current source CS is connected.

The value of the third resistive element R3 and the value of the fourth resistive element R4 are defined according to the envelope required for detecting the interference on the common mode of the signals CANL and CANH. These values can be equal to or different from each other.

In particular, the third resistive element R3 and the fourth resistive element R4 make it possible to define a voltage VMID on the first terminal of the third resistive element R3 and a voltage VB on the second terminal of the fourth resistive element R4.

The voltage VMID corresponds to the voltage of the common mode.

The voltage VB corresponding to the voltage of the common mode minus a threshold voltage, for example 200 millivolts.

The interference-detection circuit comprises a low-pass filter LPF. The low-pass filter LPF has an input connected to the second terminal of the third resistive element R3 and to the first terminal of the fourth resistive element R4.

The low-pass filter LPF has an output configured to deliver a voltage VA. The voltage VA corresponds to the voltage of the common mode minus a threshold voltage, for example 100 millivolts.

The output of the low-pass filter LPF is connected to two comparators CMP1, CMP2 in order to generate an inverse envelope used for monitoring the common mode of the signals CANL and CANH.

In particular, the interference-detection circuit DETC comprises a first voltage comparator CMP1. This first comparator CMP1 has a first input, in particular an inverting input, connected to the first terminal of the third resistive element R3 in order to receive the voltage VMID.

The first comparator CMP1 also has a second input, in particular a non-inverting input, connected to the output of the low-pass filter LPF, more particularly to the output of the low-pass filter LPF so as to receive the voltage VA.

The first comparator CMP1 has an output configured to deliver a voltage corresponding to the difference between the voltage VA and the voltage VMID.

The interference-detection circuit DETC also comprises a second voltage comparator CMP2. This second comparator CMP2 has a first input, in particular an inverting input, connected to the output of the low-pass filter LPF, more particularly to the output of the low high-pass filter LPF so as to receive the voltage VA.

The second comparator CMP2 also has a second input, in particular a non-inverting input, connected to the second terminal of the fourth resistive element R4 and to the first terminal of the current source CS in order to receive the voltage VB.

The second comparator CMP2 has an output configured to deliver a voltage corresponding to the difference between the voltage VA and the voltage VMID.

The first comparator CMP1 and the second comparator CMP2 make it possible to compare the common mode of the signals CANH and CANL with the inverse envelope defined. Advantageously, the comparators CMP1, CMP2 are implemented in the integrated circuit IC in order to be sufficiently rapid to detect the transitions between dominant mode and recessive mode.

The interference-detection circuit DETC also comprises an adding circuit ADD configured to add the signal output from the first comparator CMP1 and the signal output from the second comparator CMP2. In particular, the adding circuit ADD has a first input connected to the output of the first comparator CMP1 and a second input connected to the output of the second comparator CMP2.

This adding circuit ADD makes it possible to detect glitches, i.e. brief pulses (positive or negative) on the common mode leaving the defined envelope. Thus the adding circuit ADD makes it possible to detect whether a correction to the synchronization of the signals CANL and CANH is required. FIG. 2 illustrates an example of a signal that can be obtained at the output of the adding circuit ADD.

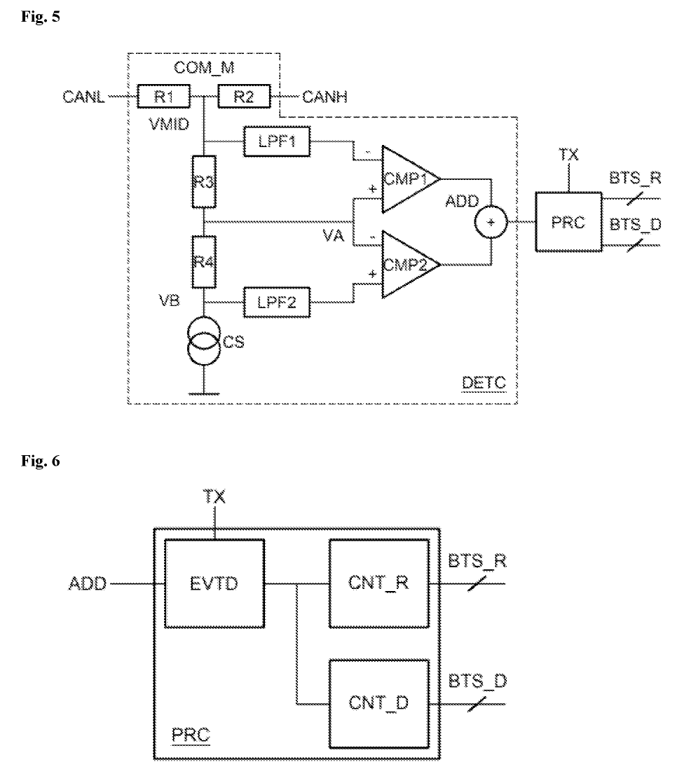

FIG. 5 illustrates a second embodiment of an interference-detection circuit DETC.

This second embodiment differs from the first embodiment in that it makes it possible to define an envelope rather than an inverse envelope. This is because, instead of defining an inverse envelope using a single low-pass filter LPF, two low-pass filters LPF1, LPF2 are used to define the envelope for monitoring the common mode of the signals CANH and CANL.

Thus a first low-pass filter LPF1 has an input connected to the first terminal of the third resistive element R3 and an output connected to an input of the first comparator CMP1. This first low-pass filter LPF1 makes it possible to define a first voltage threshold of the envelope.

The second low-pass filter LPF2 has an input connected to the second terminal of the fourth resistive element R4 and an output connected to an input of the second comparator CMP2. This second low-pass filter LPF2 makes it possible to define a second voltage threshold of the envelope.

The first comparator CMP1 and the second comparator CMP2 are then configured to receive the common mode of the signals CANH and CANL while being connected to the second terminal of the third resistive element R3 and to the first terminal of the fourth resistive element R4.

Compared with this second embodiment, the first embodiment of the interference-detection circuit DETC illustrated in FIG. 4 has the advantage of occupying a smaller space in the integrated circuit because of the use of a single low-pass filter LPF in place of two low-pass filters LPF1, LPF2.

FIG. 6 illustrates an embodiment of a processing circuit PRC. This processing circuit PRC comprises an event-monitoring circuit EVTD and two counters CNT_R, CNT_D.

The event monitoring circuit EVTD is connected to the output of the adding circuit ADD in order to detect whether the value of the adjustment bits are adjusted according to the value output from the adding circuit.

The event-monitoring circuit EVTD can for example comprise a flip-flop configured to be reinitialized at each change to dominant mode as well as to each change to recessive mode using the control signal TX.

According to the mode of the signals CANH and CANL indicated by the control signal TX, the counter CNT_R or the counter CNT_D can be incremented by the event-monitoring circuit EVTD when the value of the adjustment bits are adjusted when a synchronization correction is required.

In particular, the counter CNT_D is used for adjusting the adaptation bits for the dominant mode, and the counter CNT_R is used for adjusting the adaptation bits for the recessive mode.

The value of each counter CNT_R, CNT_D makes it possible to define the adaptation bits to be adjusted.

For example, each digital adaptation signal TMR_R, TMR_D includes M adaptation bits. Each counter CNT_R, CNT_D can then be an N-bit counter making it possible to adapt N least significant bits of the digital adaptation signal TMR_R or TMR_D, N being less than M. Each adaptation signal TMR_R, TMR_D can also comprise K most significant bits stored in a non-volatile memory, K being equal to M-N.

The value of the counter CNT_D associated with the dominant mode can be incremented when interference is detected on the common mode of the signals CANH and CANL, in particular during a transition to the dominant mode.

The value of the counter CNT_R associated with the recessive mode can be incremented when interference is detected on the common mode of the signals CANH and CANL, in particular during a transition to the recessive mode.

Such a processing circuit PRC makes it possible to adjust the adaptation bits simply.

What is claimed is:

1. An integrated circuit comprising:
a digital processing unit;
a transceiver circuit configured to transmit data between the digital processing unit and a Controller Area Network (CAN) data bus, the transceiver circuit configured to deliver differential signals CAN High (CANH) and CAN Low (CANL), according to a dominant mode and a recessive mode, each transition of the differential signals CANH and CANL between the dominant mode and the recessive mode being synchronized using adaptation bits received by the transceiver circuit; and
an adjustment circuit configured to adjust at least one adaptation bit according to at least one comparison between a common mode of the differential signals CANH and CANL and at least one threshold voltage.

2. The integrated circuit according to claim 1, wherein the adjustment circuit is configured to automatically regulate for drifts in temperature.

3. The integrated circuit according to claim 1, wherein the adjustment circuit comprises:
a detection circuit configured to detect interference on the common mode of the differential signals CANH and CANL; and
a processing circuit configured to adjust the at least one adaptation bit in response to the interference on the common mode being detected by the detection circuit.

4. The integrated circuit according to claim 3, wherein the digital processing unit is configured to deliver a control signal indicating the mode of the differential signals CANL and CANH, and wherein the processing circuit is configured to receive the control signal in order to adapt the at least one adaptation bit associated with the transition to the mode of the differential signals CANL and CANH corresponding to the mode indicated by the control signal in response to the interference being detected by the detection circuit.

5. The integrated circuit according to claim 4, wherein the detection circuit is configured to receive the differential signals CANH and CANL and comprises:
a first resistive element and a second resistive element connected in series and configured to receive the differential signals CANL and CANH so as to obtain the common mode of the differential signals CANL and CANH on a common node between the first resistive element and the second resistive element;
a third resistive element, a fourth resistive element and a current source connected in series between the common node of the first resistive element and of the second resistive element and a reference node;
a low-pass filter having an input connected to a common node between the third resistive element and the fourth resistive element so as to generate at an output a threshold voltage for monitoring the common mode of the differential signals CANH and CANL;
a first comparator having a first input connected to the common node between the first resistive element and the second resistive element, and a second input connected to the output of the low-pass filter;
a second comparator having a first input connected to a common node between the fourth resistive element and the current source, and a second input connected to the output of the low-pass filter; and
an adding circuit having two inputs connected respectively to outputs of the first and second comparators, and an output connected to the processing circuit.

6. The integrated circuit according to claim 4, wherein the processing circuit comprises:
a first counter configured to be incremented in response to first interference being detected on the common mode by the detection circuit during a transition to the dominant mode, a first value of the first counter defining at least one first adaptation bit for the transition to the dominant mode; and
a second counter configured to be incremented in response to second interference being detected on the common mode by the detection circuit during a transition to the recessive mode, a second value of the second counter defining at least one second adaptation bit for the transition to the recessive mode.

7. The integrated circuit according to claim 6, wherein the processing circuit comprises an event-monitoring circuit connected to an output of the detection circuit and being configured to increment, in response to the interference being detected, the first counter or the second counter according to the mode of the differential signals CANH and CANL indicated by the control signal delivered by the digital processing unit.

8. An electronic system comprising:
a Controller Area Network (CAN) data bus;
a first electronic device coupled to the CAN data bus;
a second electronic device coupled to the CAN data bus, wherein each electronic device includes an integrated circuit comprising:
a digital processing unit;
a transceiver circuit configured to transmit data between the digital processing unit and the CAN data bus, the transceiver circuit configured to deliver differential signals CAN High (CANH) and CAN Low (CANL), according to a dominant mode and a recessive mode, each transition of the differential signals CANH and CANL between the dominant mode and the recessive mode being synchronized using adaptation bits received by the transceiver circuit; and
an adjustment circuit configured to adjust at least one adaptation bit according to at least one comparison between a common mode of the differential signals CANH and CANL and at least one threshold voltage.

9. The integrated circuit according to claim 8, wherein the adjustment circuit is configured to automatically regulate for drifts in temperature.

10. The electronic system according to claim 8, wherein the adjustment circuit comprises:
a detection circuit configured to detect interference on the common mode of the differential signals CANH and CANL; and
a processing circuit configured to adjust the at least one adaptation bit in response to the interference on the common mode being detected by the detection circuit.

11. The electronic system according to claim 10, wherein the digital processing unit is configured to deliver a control signal indicating the mode of the differential signals CANL and CANH, and wherein the processing circuit is configured to receive the control signal in order to adapt the at least one adaptation bit associated with the transition to the mode of the differential signals CANL and CANH corresponding to the mode indicated by the control signal in response to the interference being detected by the detection circuit.

12. The electronic system according to claim 11, wherein the detection circuit is configured to receive the differential signals CANH and CANL and comprises:
a first resistive element and a second resistive element connected in series and configured to receive the differential signals CANL and CANH so as to obtain the common mode of the differential signals CANL and CANH on a common node between the first resistive element and the second resistive element;
a third resistive element, a fourth resistive element and a current source connected in series between the common node of the first resistive element and of the second resistive element and a reference node;
a low-pass filter having an input connected to a common node between the third resistive element and the fourth resistive element so as to generate at an output a threshold voltage for monitoring the common mode of the differential signals CANH and CANL;
a first comparator having a first input connected to the common node between the first resistive element and the second resistive element, and a second input connected to the output of the low-pass filter;
a second comparator having a first input connected to a common node between the fourth resistive element and the current source, and a second input connected to the output of the low-pass filter; and
an adding circuit having two inputs connected respectively to outputs of the first and second comparators, and an output connected to the processing circuit.

13. The electronic system according to claim 11, wherein the processing circuit comprises:
a first counter configured to be incremented in response to first interference being detected on the common mode by the detection circuit during a transition to the dominant mode, a first value of the first counter defining at least one first adaptation bit for the transition to the dominant mode; and
a second counter configured to be incremented in response to second interference being detected on the common mode by the detection circuit during a transition to the recessive mode, a second value of the second counter defining at least one second adaptation bit for the transition to the recessive mode.

14. The electronic system according to claim 13, wherein the processing circuit comprises an event-monitoring circuit connected to an output of the detection circuit and being configured to increment, in response to the interference being detected, the first counter or the second counter according to the mode of the differential signals CANH and CANL indicated by the control signal delivered by the digital processing unit.

15. A method of operating an integrated circuit, the method comprising:
transmitting, by a transceiver circuit, data between a digital processing unit and a Controller Area Network (CAN) data bus, the transmitting comprising:
delivering differential signals CAN High (CANH) and CAN Low (CANL) according to a dominant mode and a recessive mode;
received adaptation bits; and
synchronizing each transition of the differential signals CANH and CANL between the dominant mode and the recessive mode using the adaptation bits; and
comparing, by an adjustment circuit, a common mode of the differential signals CANH and CANL and at least one threshold voltage; and
adjusting, by the adjustment circuit, at least one adaptation bit according to the comparing.

16. The method according to claim 15, further comprising automatically regulating the adjustment circuit for drifts in temperature.

17. The method according to claim 15, further comprising:
detecting, by a detection circuit of the adjustment circuit, interference on the common mode of the differential signals CANH and CANL; and
adjusting, by a processing circuit of the adjustment circuit, the at least one adaptation bit in response to the detecting.

18. The method according to claim 17, further comprising:
delivering, by the digital processing unit, a control signal indicating the mode of the differential signals CANL and CANH; and
receiving, by the processing circuit, the control signal in order to adapt the at least one adaptation bit associated with the transition to the mode of the differential signals CANL and CANH corresponding to the mode indicated by the control signal in response to the detecting.

19. The method according to claim 18, further comprising:
incrementing a first counter of the processing circuit in response to first interference being detected on the common mode by the detection circuit during a transition to the dominant mode, a first value of the first counter defining at least one first adaptation bit for the transition to the dominant mode; and
incrementing a second counter of the processing circuit in response to second interference being detected on the common mode by the detection circuit during a transition to the recessive mode, a second value of the second counter defining at least one second adaptation bit for the transition to the recessive mode.

20. The method according to claim 19, further comprising incrementing, by an event-monitoring circuit of the processing circuit, in response to the interference being detected, the first counter or the second counter according to the mode of the differential signals CANH and CANL indicated by the control signal delivered by the digital processing unit.
